(19) United States
(12) Patent Application Publication
(10) Pub. No.: US 2026/0104072 A1
(43) Pub. Date: Apr. 16, 2026

(54) BEARING SYSTEM

(71) Applicant: Mazda Motor Corporation, Aki-gun (JP)

(72) Inventor: Yusuke Nakao, Aki-gun (JP)

(21) Appl. No.: 19/349,087

(22) Filed: Oct. 3, 2025

(30) Foreign Application Priority Data
Oct. 15, 2024 (JP) 2024-179810

(51) Int. Cl. F16C 33/10; F16C 17/12; F16C 37/00

(52) U.S. Cl. CPC F16C 33/1045; F16C 17/12; F16C 33/1065; F16C 37/002; F16C 2380/26

(57) ABSTRACT

A bearing system is capable of accurately and simultaneously securing a load capacity of a slide bearing and reducing friction without complicating control. The slide bearing of the bearing system includes: two groove portions that are formed on a sliding surface thereof and extend in a radial direction and a circumferential direction, and these groove portions divide the sliding surface of the slide bearing into a plurality of divided sections in an axial direction. The slide bearing also includes: a discharge hole that is formed in the groove portions to discharge a fluid from the slide bearing; and supply holes for supplying the fluid to the divided sections, which are divided by the groove portions. The slide bearing further supplies oil and CO₂ refrigerant having different viscosities from the respective supply holes, to the one divided section of the plurality of divided sections.

### TECHNICAL FIELD

The present disclosure relates to a bearing system that supports a rotation shaft by a slide bearing lubricated by a fluid.

### BACKGROUND ART

Conventionally, a slide bearing configured to be lubricated by a fluid (a working fluid) such as oil to support a rotation shaft has been known. This type of a technique is described in JP2022-155811A, for example. More specifically, JP2022-155811A discloses a technique of making an auxiliary bearing as a rolling bearing function as a slide bearing (a fluid bearing) by supplying a refrigerant (example of the fluid) to a gap between an inner wheel thereof and the rotation shaft and thereby alleviating an effect of frictional heat that is generated in the auxiliary bearing and the rotation shaft.

### SUMMARY

### TECHNICAL PROBLEM

Here, the present inventors have studied an application of a slide bearing to a rotation shaft such as that of a motor that can rotate at a high rotational frequency (for example, a motor of an electric vehicle), and have obtained the following knowledge in a process of developing this slide bearing.

First, when the rotational frequency of the rotation shaft is relatively low, a load capacity of the slide bearing tends to be low. Meanwhile, when the rotational frequency of the rotation shaft is relatively high, the load capacity of the slide bearing tends to be increased due to a wedge effect and a throttle effect, but loss (friction loss) due to resistance of a fluid tends to also be increased. Accordingly, it can be said that it is desirable to secure the load capacity of the slide bearing in a low rotation range of the rotation shaft, and that it is desirable to suppress the load capacity of the slide bearing to reduce the friction loss in a high rotation range of the rotation shaft. Thus, the present inventors have considered controlling the load capacity of the slide bearing by preparing a plurality of types of the fluids having different viscosities, supplying a fluid, which is produced by mixing this plurality of fluids, to the slide bearing, and adjusting a ratio of mixing the plurality of fluids (a mixing ratio) according to the rotational frequency of the rotation shaft, that is, changing a viscosity of the fluid by adjusting the mixing ratio. In this case, in the low rotation range of the rotation shaft, the mixing ratio only needs to be adjusted in a manner which increases the viscosity of the fluid to be supplied to the slide bearing, and in the high rotation range of the rotation shaft, the mixing ratio only needs to be adjusted in a manner which reduces the viscosity of the fluid to be supplied to the slide bearing. As a result, it is possible to simultaneously secure the load capacity of the slide bearing and reduce the friction.

However, as a result of the intensive studies by the present inventors, it was found that, since the viscosity of the fluid and the like varied due to effects of a temperature change, a pressure fluctuation, and the like, it was difficult to set a desired viscosity of the fluid to be supplied to the slide bearing by adjusting the mixing ratio as described above. In particular, in environments with severe heat or extreme cold, a variation in the viscosity is increased, and thus the fluid tends to deviate from the desired viscosity (e.g., the viscosity of the fluid tends to be reduced with severe heat). As a result, the load capacity of the slide bearing cannot be accurately controlled. Here, as a method for accurately setting the fluid to the desired viscosity, there is a method for measuring the pressure, the temperature, and the viscosity of the fluid as needed and finely controlling the mixing ratio of the fluid according to the measurement result. However, this method complicates a system configuration and a control configuration.

The present disclosure has been made to solve the problems of the related art described above, and an object of the present disclosure is to provide a bearing system capable of accurately and simultaneously securing the load capacity of the slide bearing and reducing friction without complicating control.

### SOLUTION TO PROBLEM

In order to achieve the above object, the present disclosure provides a bearing system that supports a rotation shaft and includes a slide bearing lubricated by a fluid, the slide bearing supporting the rotation shaft. The slide bearing includes: a groove portion that is formed on a sliding surface of the slide bearing and extends in a radial direction and a circumferential direction, the groove portion dividing the sliding surface into a plurality of sections in an axial direction; a discharge hole that is formed in the groove portion to discharge the fluid from the slide bearing; and a plurality of supply holes for supplying the fluid to the plurality of sections, which are divided by the groove portion, respectively. The slide bearing is configured to supply each of the plurality of fluids having different viscosities from the respective supply hole to one or more predetermined sections of the plurality of sections.

According to this configuration, the slide bearing divides the sliding surface into a plurality of divided sections (example of the plurality of sections) in the axial direction by the groove portion, and separately supplies the plurality of fluids having the different viscosities to the one or more predetermined divided sections of the plurality of divided sections. Thus, it is possible to appropriately change the viscosity of the fluid in the predetermined divided section. As a result, it is possible to change an average viscosity of the fluid in the slide bearing and to control a load of the slide bearing. In particular, in this configuration, since the plurality of divided sections are formed by the groove portion, and this groove portion is provided with the discharge hole, the fluid in each of the divided sections flows out from the discharge hole through the groove portion that defines each of the divided sections. Thus, it is possible to prevent the fluids from being mixed in an adjacent two of the divided sections. Accordingly, since the viscosity in each of the divided sections does not fluctuate due to mixing of the plurality of fluids, the viscosity of the fluid in each of the divided sections can be accurately adjusted. Thus, it is possible to realize the desired average viscosity in the slide bearing. Therefore, according to this configuration, since the load of the slide bearing can be accurately controlled, it is possible to accurately and simultaneously secure load capacity of the slide bearing and reduce friction without complicating a control configuration and the like in comparison with a configuration that the viscosity of the fluid is changed by adjusting a mixing ratio of the plurality of fluids as described above.

In the present disclosure, preferably, the slide bearing is configured to be supplied with the fluids having the different viscosities from the plurality of supply holes, respectively.

According to this configuration, the viscosity of the fluid can be made different for each of the divided sections in the slide bearing.

In the present disclosure, preferably, the plurality of sections comprise three or more sections, and the groove portion is one of two or more groove portions of the slide bearing that are provided to form the three or more sections.

According to this configuration, variations in the average viscosity of the fluid in the slide bearing can be increased by using a large number of divided sections, and thus it is possible to switch the load of the slide bearing in multiple stages.

In the present disclosure, preferably, the groove portion of the slide bearing is arranged such that lengths along the axial direction of the plurality of sections differ from each other.

According to this configuration, it is possible to realize the desired average viscosity in the slide bearing by appropriately setting the length along the axial direction of each of the plurality of divided sections.

In the present disclosure, preferably, the plurality of supply holes include two supply holes, and the plurality of fluids include a first fluid and a second fluid having a lower viscosity than the first fluid.

According to this configuration, it is possible to reliably switch the viscosity in the predetermined divided section in two stages.

In the present disclosure, preferably, the bearing system further includes: a first passage and a second passage that respectively communicate with the two supply holes and supply the first fluid and the second fluid; a first valve and a second valve respectively provided in the first passage and the second passage; and a controller that controls opening/closing of each of the first valve and the second valve to switch the fluid to be supplied to the predetermined section between the first fluid and the second fluid.

According to this configuration, it is possible to reliably switch the viscosity in the predetermined divided section when the controller controls opening/closing of each of the first and second valves.

In the present disclosure, preferably, based on a rotational frequency of the rotation shaft, the controller selectively executes a control for opening the first valve and closing the second valve to supply the first fluid to the predetermined section and a control for closing the first valve and opening the second valve to supply the second fluid to the predetermined section.

According to this configuration, it is possible to accurately and simultaneously secure the load capacity of the slide bearing and reduce the friction by switching the supply of the first and second fluids to the predetermined divided section according to the rotational frequency of the rotation shaft.

In the present disclosure, preferably, the controller executes the control for opening the first valve and closing the second valve to supply the first fluid to the predetermined section, thereafter executes the control for closing the first valve and opening the second valve to supply the second fluid to the predetermined section, and, after this control, executes a control for closing the first and second valves to stop supply of the first and second fluids to the predetermined section.

According to this configuration, after stopping the supply of the first fluid having a relatively high viscosity to the predetermined divided section, the second fluid having a relatively low viscosity is supplied to the predetermined divided section, and the first fluid remaining in the predetermined divided section can thereby be cleaned with the second fluid. In this way, it is possible to suppress resistance caused by drag of the first fluid. In addition, according to the present disclosure, the supply of the second fluid to the predetermined divided section is stopped after the first fluid remaining in the predetermined divided section is cleaned with the second fluid, just as described. Thus, it is possible to suppress wasteful energy consumption of preparing the second fluid.

In a preferred example of the present disclosure, preferably, the plurality of fluids include oil and CO₂.

In this case, in a further preferred example, preferably, the bearing system is configured to support the rotation shaft of a motor by the slide bearing.

### ADVANTAGEOUS EFFECTS

According to the bearing system of the present disclosure, it is possible to accurately and simultaneously secure the load capacity of the slide bearing and reduce the friction without complicating the control.

### BRIEF DESCRIPTION OF DRAWINGS

FIG. 1 is a schematic configuration view of a vehicle to which a bearing system according to an embodiment of the present disclosure is applied.

FIG. 2 is a schematic configuration view of a refrigerant circulation system according to the embodiment of the present disclosure.

FIG. 3 is a schematic configuration view of a motor and the like according to the embodiment of the invention.

FIGS. 4A and 4B are schematic configuration views of the bearing system according to the embodiment of the present disclosure.

FIGS. 5A and 5B are views illustrating a load realized by the bearing system according to the embodiment of the present disclosure.

FIG. 6 is a block diagram illustrating an electrical configuration of the bearing system according to the embodiment of the present disclosure.

FIG. 7 is a time chart illustrating control according to the embodiment of the present disclosure.

FIG. 8 is a flowchart illustrating the control according to the embodiment of the present disclosure.

FIG. 9 includes views illustrating control according to a first modified example of the embodiment of the present disclosure.

FIG. 10 is a time chart illustrating the control according to the first modified example of the embodiment of the present disclosure.

FIG. 11 is a flowchart illustrating the control according to the first modified example of the embodiment of the present disclosure.

FIG. 12 is a schematic configuration view of a bearing system according to a second modified example of the embodiment of the present disclosure.

FIGS. 13A to 13D include views illustrating the control according to the second modified example of the embodiment of the present disclosure.

FIG. 14 is an explanatory graph of a load realized by the second modified example of the embodiment of the present disclosure.

### DETAILED DESCRIPTION

Hereinafter, a bearing system according to an embodiment of the present disclosure will be described with reference to the accompanying drawings.

### Overall Configuration

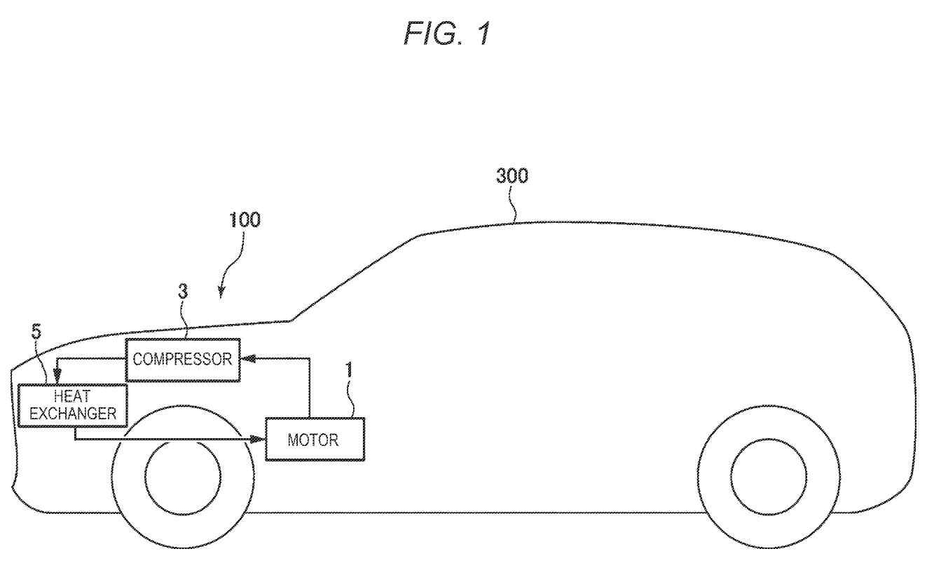

First, FIG. 1 is a schematic configuration view of a vehicle to which the bearing system according to the present embodiment is applied.

As illustrated in FIG. 1, a vehicle 300 is an electric vehicle, for example, and includes a refrigerant circulation system 100 that circulates a refrigerant in a refrigeration cycle. This refrigerant circulation system 100 mainly includes: a motor 1 (an electric motor) that generates power for driving the vehicle 300; a compressor 3 that compresses the refrigerant to be supplied to the motor 1; and a heat exchanger 5 that includes a condenser, a fan, and the like and cools the refrigerant compressed by the compressor 3.

The refrigerant circulation system 100 circulates a CO₂ refrigerant (hereinafter, also simply referred to as the "refrigerant") as a natural refrigerant. This CO₂ refrigerant contains not only CO₂ but also oil (refrigerant oil) such as polyalkylene glycol (PAG), an additive, and the like. Due to use of such a CO₂ refrigerant, the compressor 3 is configured to compress the refrigerant at an extremely high pressure. The motor 1 uses the refrigerant (typically a refrigerant in a supercritical state), which is thus compressed by the compressor 3, to lubricate a slide bearing supporting a rotation shaft and to cool a rotor and a stator. In this case, the motor 1 is configured to function as an evaporator in the refrigeration cycle. For example, in the refrigerant circulation system 100, a high-temperature liquid refrigerant is supplied from the compressor 3 to the heat exchanger 5, a low-temperature liquid refrigerant is supplied from the heat exchanger 5 to the motor 1, and a high-temperature gas refrigerant is supplied from the motor 1 to the compressor 3. The refrigerant that is compressed by the compressor 3 may be used for air conditioning by an air conditioner, cooling of a battery, or the like.

### Configuration of Refrigerant Circulation System

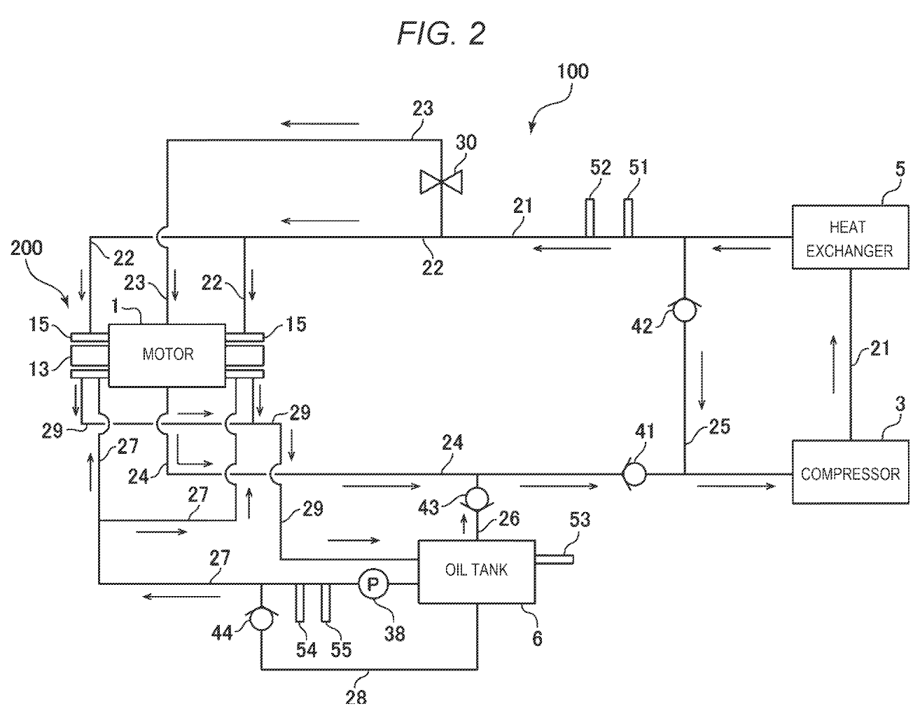

Next, a specific description will be made on the refrigerant circulation system 100 according to the present embodiment with reference to FIG. 2. FIG. 2 is a schematic configuration view of the refrigerant circulation system 100 according to the present embodiment.

As illustrated in FIG. 2, the refrigerant circulation system 100 mainly includes, in addition to the motor 1, the compressor 3, and the heat exchanger 5 described above: a bearing system 200 that includes a pair of slide bearings 15 supporting a rotation shaft 13 of the motor 1; an oil tank 6 that stores the oil used for lubrication of the slide bearings 15 and the like; refrigerant passages 21 to 26 through each of which the refrigerant (e.g. the CO₂ refrigerant) flows; oil passages 27, 28 through which the oil flows; and at least one mixed fluid passage 29 through which a mixed fluid of the refrigerant and the oil flows. For example, the oil is the refrigerant oil such as PAG.

The refrigerant passage 21 is a passage for supplying the refrigerant from the compressor 3 to the motor 1 and the like via the heat exchanger 5, and is branched into the refrigerant passage 22 and the refrigerant passage 23 downstream of the heat exchanger 5. The refrigerant passage 21 is provided with a refrigerant temperature sensor 51 that detects the temperature of the refrigerant and a refrigerant pressure sensor 52 that detects a pressure of the refrigerant.

Hereinafter, description with respect to FIG. 2 will be made to mainly one of the slide bearings 15 as a representative example of the pair. The refrigerant passage 22 is a passage for supplying the refrigerant into the slide bearing 15, and the refrigerant passage 23 is a passage for supplying the refrigerant into the motor 1. These refrigerant passages 22, 23 supply the liquid refrigerant (typically in the supercritical state) to the slide bearing 15 and the motor 1, respectively. The refrigerant supplied to the slide bearing 15 is used to lubricate the slide bearing 15, and the refrigerant supplied to the motor 1 is used to cool the inside of the motor 1. The refrigerant passage 23 is provided with a flow rate adjustment valve 30 that adjusts a flow rate of the refrigerant.

The refrigerant passage 24 is a passage for supplying the refrigerant discharged from the motor 1 to the compressor 3. A refrigerant passage 25 is connected to the refrigerant passage 24. This refrigerant passage 25 has one end that is connected to the refrigerant passage 21 downstream of the heat exchanger 5 and the other end that is connected to the refrigerant passage 24, and functions to return the refrigerant from the heat exchanger 5 to the compressor 3 without interposing the motor 1, the slide bearing 15, and the like. The refrigerant passages 24, 25 are provided with check valves 41, 42, respectively.

The at least one oil passage 27 is a passage for supplying the oil stored in the oil tank 6 to the slide bearing 15. The oil supplied to the slide bearing 15 is used to lubricate the slide bearing 15 together with the refrigerant described above. The at least one oil passage 27 is provided with: an oil pump 38 for pressure-feeding the oil; an oil temperature sensor 54 that detects a temperature of the oil; and a hydraulic pressure sensor 55 that detects a pressure of the oil. The oil passage 28 for returning the oil in the at least one oil passage 27 to the oil tank 6 is connected to the at least one oil passage 27. This oil passage 28 is provided with a check valve 44.

The at least one mixed fluid passage 29 is a passage for supplying the mixed fluid of the refrigerant and the oil discharged from the slide bearing 15 to the oil tank 6. The oil tank 6 is configured to separate the oil in the mixed fluid supplied from this at least one mixed fluid passage 29 (gas-liquid separation) and store the separated oil while supplying the rest of the refrigerant (containing a slight amount of the oil) from the refrigerant passage 26 to the refrigerant passage 24 described above. This refrigerant passage 26 is provided with a check valve 43. The oil tank 6 is provided with an oil level sensor 53 that detects a level of the stored oil.

### Configuration of Bearing System

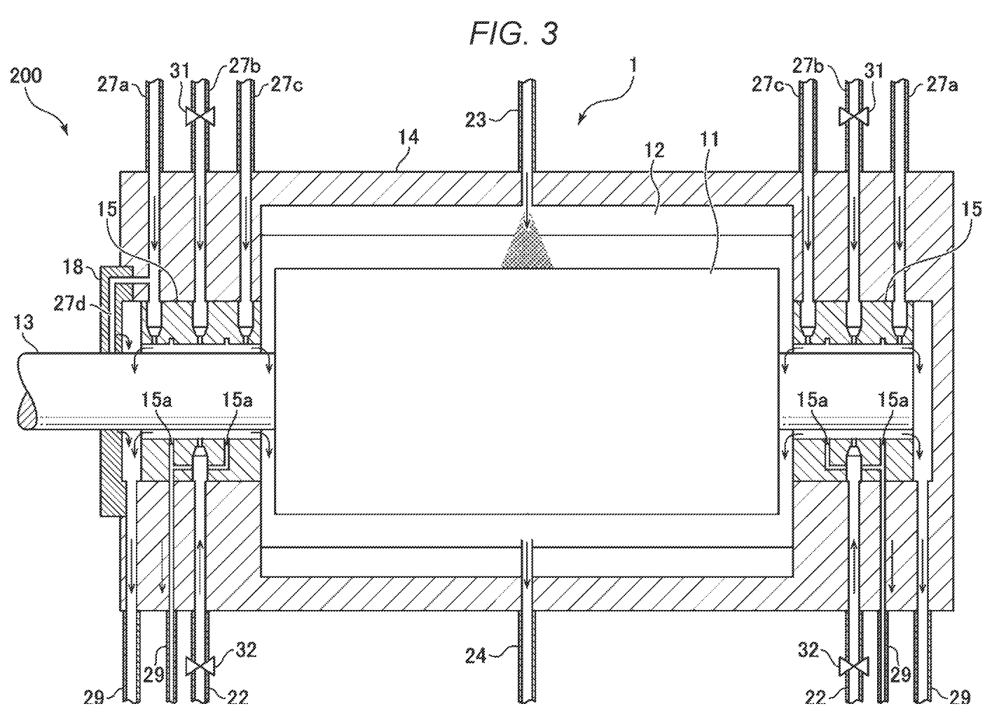

Next, a specific description will be made of a configuration of the bearing system 200 according to the present embodiment with reference to FIGS. 3 to 5.

First, FIG. 3 is a schematic configuration view of the motor 1 and the bearing system 200 according to the present embodiment. More specifically, FIG. 3 is a cross-sectional view in which the motor 1 and the bearing system 200 are viewed along an axial direction. Here, FIG. 3 illustrates vertical positions of the refrigerant passage 22 and the at least one oil passage 27 in reverse of the positions in FIG. 2 (the same applies to the drawings described below).

As illustrated in FIG. 3, the motor 1 mainly includes a rotor 11, a stator 12, the rotation shaft 13 coupled to this rotor 11 and having one end connected to a transaxle (not illustrated) of the vehicle 300 or the like, and a housing 14 that accommodates the rotor 11, stator 12, and rotation shaft 13, and the bearing system 200 mainly includes the pair of the slide bearings 15 that supports the rotation shaft 13 of the motor 1. The pair of the slide bearings 15 is also accommodated in the housing 14 of the motor 1.

As described above, in the motor 1, the refrigerant (the liquid refrigerant) is supplied from the refrigerant passage 23 to the rotor 11 and the stator 12. The refrigerant that is supplied to the motor 1, just as described, is used to cool the rotor 11 and the stator 12, in particular, to cool a coil (not illustrated) in the stator 12. In this case, since the refrigerant exchanges heat with the stator 12 and the like at a relatively high temperature (at this time, the refrigerant is evaporated in the coil of the stator 12), the function of the evaporator in the refrigeration cycle is realized. Then, the refrigerant used for cooling in the motor 1 is discharged from the refrigerant passage 24.

Subsequently, the pair of the slide bearings 15 are arranged to oppose each other symmetrically (bilaterally symmetrically) across the rotor 11 in the axial direction. Each of the paired slide bearings 15 is supplied with the oil from the plurality of (e.g. three) oil passages 27 (e.g. 27a, 27b, 27c) and supplied with the refrigerant from the single refrigerant passage 22, which branches into two separate sub passages to reach the separate slide bearings 15. The refrigerant and oil are supplied to a gap between an inner peripheral surface of each of the slide bearings 15 and an outer peripheral surface of the rotation shaft 13 of the motor 1, and are thereby used for lubrication when the slide bearings 15 support the rotation shaft 13. The refrigerant and the oil used to lubricate the slide bearings 15 are discharged together as the mixed fluid from the at least one mixed fluid passage 29. The refrigerant used to lubricate the slide bearings 15, in particular, the refrigerant used in an end portion of the slide bearing 15 located on the rotor 11 side flows into a space of the housing 14 where the rotor 11 and the stator 12 are accommodated, and is discharged from the refrigerant passage 24 together with the refrigerant used to cool the motor 1.

More specifically, the oil passages 27a, 27b, 27c supply the oil to different positions (e.g. three positions) along the axial direction of each of the slide bearings 15, and the refrigerant passage 22 supplies the refrigerant to the same position as the position where the oil passage 27b supplies the oil in the axial direction. In this case, the refrigerant is not supplied to the positions where the oil passages 27a, 27c supply the oil. In addition, the oil passage 27b is provided with an oil bearing valve 31 capable of switching supply/blockage of the oil by opening/closing, and the refrigerant passage 22 is provided with a refrigerant bearing valve 32 capable of switching supply/blockage of the refrigerant by opening/closing.

Meanwhile, the housing 14 of the motor 1 is provided with a seal member 18 for sealing a side of the rotation shaft 13 connected to the transaxle or the like (a side provided with the slide bearing 15 and illustrated on the left in FIG. 3). This seal member 18 is provided to prevent leakage of the fluid from a gap between the housing 14 and a portion of the rotation shaft 13 extending outward from the housing 14. The seal member 18 is configured as a mechanical seal that is supplied with the oil from the oil passage 27d connected to the oil passage 27a described above and uses this oil to prevent the leakage of the fluid.

Here, the oil is an example of a "first fluid" in the present disclosure, and the refrigerant (the CO₂ refrigerant) is an example of a "second fluid" in the present disclosure. The oil passage 27b and the refrigerant passage 22 are examples of a "first passage" and a "second passage" in the present disclosure, respectively, and the oil bearing valve 31 and the refrigerant bearing valve 32 are examples of a "first valve" and a "second valve" in the present disclosure, respectively.

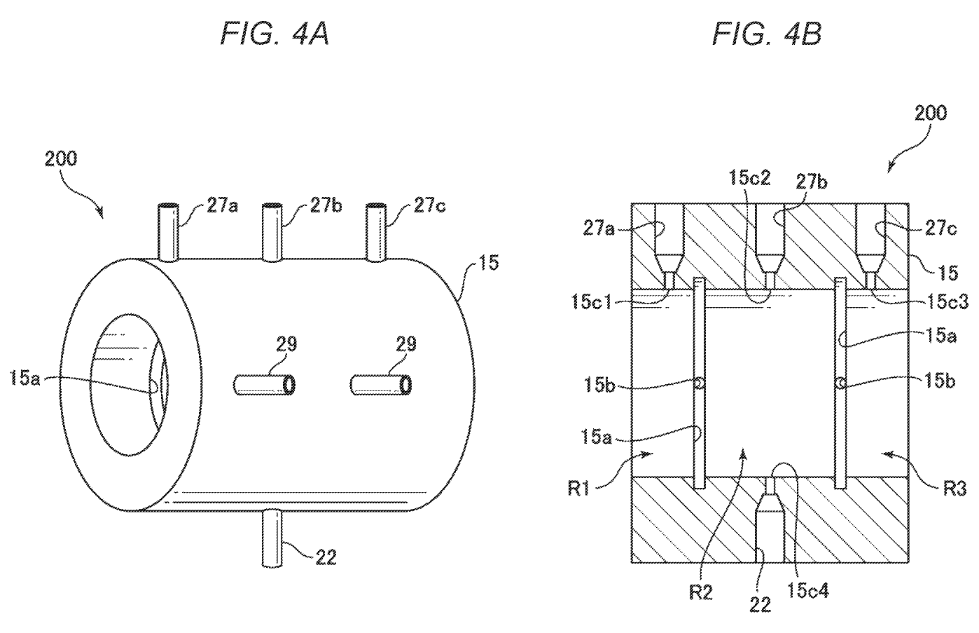

Next, FIG. 4 includes schematic configuration views for more specifically illustrating the bearing system 200 according to the present embodiment. More specifically, FIG. 4A is a perspective view of one of the paired slide bearings 15 in the bearing system 200 (the slide bearing 15 illustrated on the left in FIG. 3, that is, the slide bearing 15 on the side where the seal member 18 is provided), and FIG. 4B is a cross-sectional view in which this one slide bearing 15 is viewed along the axial direction.

As illustrated in FIGS. 4A and 4B, in particular FIG. 4B, each of the slide bearings 15 has two annular groove portions 15a that are formed on a sliding surface (the inner peripheral surface) thereof, extend in a radial direction, and extend over an entire circumference in a circumferential direction. These two groove portions 15a of the slide bearing 15 divide the sliding surface of the slide bearing 15 into three divided sections R1 to R3 in the axial direction. The divided sections R1, R3 in both end portions have substantially the same length along the axial direction. However, the divided section R2 in an intermediate portion sandwiched between these divided sections R1, R3 is longer along the axial direction than the divided sections R1, R3.

The slide bearing 15 further includes: a discharge hole 15b that is formed in each of the two groove portions 15a to discharge the refrigerant and the oil from the slide bearing 15; supply holes 15c1, 15c2, 15c3 for respectively supplying the oil to the divided sections R1, R2, R3; and a supply hole 15c4 for supplying the refrigerant to the divided section R2. The discharge hole 15b communicates with the at least one mixed fluid passage 29, the supply holes 15c1, 15c2, 15c3 communicate with the oil passages 27a, 27b, 27c, respectively, and the supply hole 15c4 communicates with the refrigerant passage 22. The two or more discharge holes 15b may be provided on the same groove portion 15a.

According to such a slide bearing 15, the three divided sections R1 to R3 are formed in the axial direction by the two groove portions 15a, and these groove portions 15a are provided with the discharge holes 15b. Thus, the fluid (the oil or the refrigerant) in each of the divided sections R1 to R3 flows out from the respective discharge hole 15b through respective one of the groove portions 15a that define the divided sections R1 to R3. In this way, it is possible to prevent the fluid from moving back and forth between the adjacent two of the divided sections R1 to R3 and thereby prevent the fluid from being mixed in the divided sections R1 to R3. This is because, since a size (for example, in an order of mm) of the groove portion 15a is significantly larger than a gap (for example, in an order of μm) between the rotation shaft 13 of the motor 1 and the slide bearing 15, the fluid in each of the divided sections R1 to R3 flows into the respective groove portion 15a without flowing to the adjacent divided section by passing the groove portion 15a.

Here, only the oil is supplied to the divided section R1 through the oil passage 27a and the supply hole 15c1, and only the oil is supplied to the divided section R3 through the oil passage 27c and the supply hole 15c3. Meanwhile, the oil is supplied to the divided section R2 through the oil passage 27b and the supply hole 15c2, and the refrigerant is supplied through the refrigerant passage 22 and the supply hole 15c4. As described above, the oil passage 27b and the refrigerant passage 22 applied to such a divided section R2 are provided with the oil bearing valve 31 and the refrigerant bearing valve 32, respectively (FIG. 3). In the present embodiment, only one of the oil or the refrigerant is supplied to the divided section R2 (that is, both the oil and the refrigerant are not supplied at the same time) by opening one of the oil bearing valve 31 and the refrigerant bearing valve 32 and closing the other thereof, and open/closed states of such an oil bearing valve 31 and a refrigerant bearing valve 32 are changed. In this way, the fluid to be supplied to the divided section R2 is switched between the oil and the refrigerant.

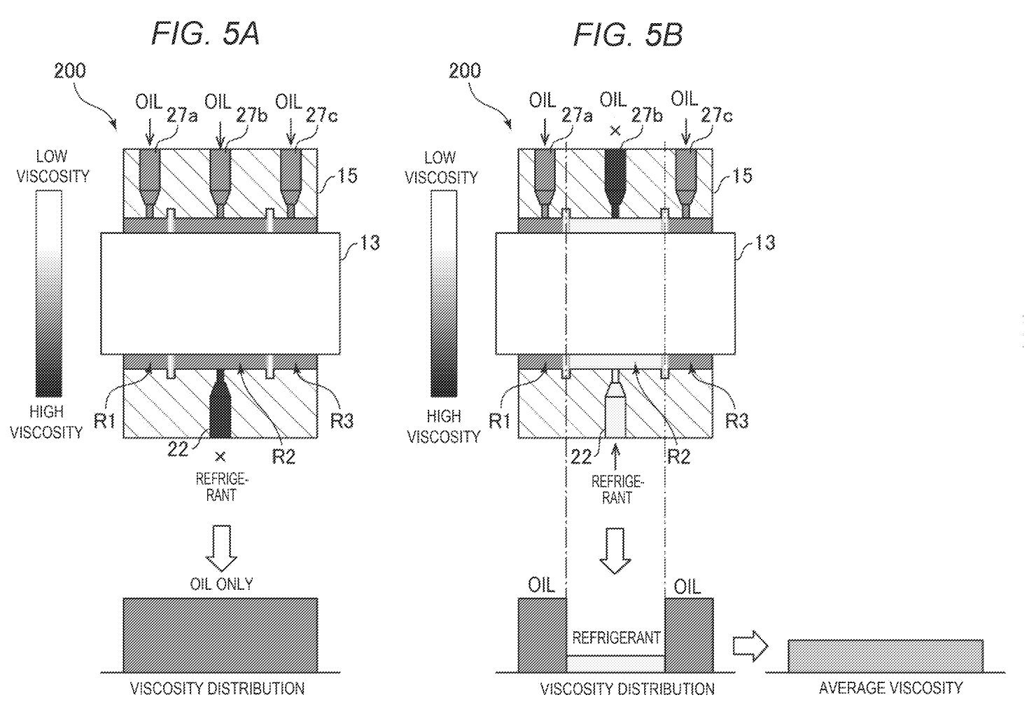

Next, FIG. 5 includes views illustrating a load realized by the bearing system 200 according to the present embodiment. More specifically, FIGS. 5A and 5B illustrate a supply state of the oil or the refrigerant in one of the paired slide bearings 15 (the slide bearing 15 illustrated on the left in FIG. 3, that is, the slide bearing 15 on the side where the seal member 18 is provided) in upper portions thereof. FIGS. 5A and 5B illustrate a viscosity distribution of the fluid in the gap between the rotation shaft 13 of the motor 1 and the slide bearing 15 in lower portions thereof. In FIGS. 5A and 5B, a magnitude of the viscosity of the fluid is indicated by shading (the oil having a high viscosity is indicated by a dark shade, and the refrigerant having a low viscosity is indicated by a light shade). In addition, "↑" or "↓" indicates the supply of the corresponding fluid, and "x" indicates stopping of the supply of the corresponding fluid. Such notation is the same in the drawings described below.

FIG. 5A illustrates a case where the oil is supplied to all of the divided sections R1 to R3. In this case, it is not the refrigerant but the oil that is applied as the fluid that is supplied to the divided section R2 (the fluid supplied to the divided sections R1, R3 is limited to the oil in this embodiment). At this time, the oil bearing valve 31 in the oil passage 27b is opened while the refrigerant bearing valve 32 in the refrigerant passage 22 is closed. As illustrated in FIG. 5A, when the oil is supplied to all of the divided sections R1 to R3, the viscosity distribution of the gap between the rotation shaft 13 of the motor 1 and the slide bearing 15 is uniform in the axial direction. In this case, the load applied by the slide bearing 15 is relatively large.

FIG. 5B illustrates a case where the oil is supplied to the divided sections R1, R3 while the refrigerant is supplied to the divided section R2. At this time, the oil bearing valve 31 in the oil passage 27b is closed while the refrigerant bearing valve 32 in the refrigerant passage 22 is opened. In the case illustrated in FIG. 5B, the viscosity distribution of the gap between the rotation shaft 13 of the motor 1 and the slide bearing 15 is not uniform in the axial direction, and the viscosity (the viscosity of the refrigerant) of the divided section R2 is lower than the viscosity (the viscosity of the oil) of the divided sections R1, R3. In this case, when an average viscosity of the viscosity distribution is calculated (lower right in FIG. 5B), this average viscosity is lower than the viscosity in FIG. 5A. As a result, the load applied by the slide bearing 15 is relatively small. For example, the load in the case illustrated in FIG. 5B is a half of the load in the case illustrated in FIG. 5A.

According to such a present embodiment, the load applied by the slide bearing 15 can be switched by switching the fluid supplied to the divided section R2 between the oil and the refrigerant. In this way, the relatively large load as illustrated in FIG. 5A can be applied in a low rotation range of the rotation shaft 13 of the motor 1, and the relatively small load as illustrated in FIG. 5B can be applied in a high rotation range of the rotation shaft 13 of the motor 1. Here, in the present embodiment, it is possible to prevent the fluid from being mixed in adjacent two of the divided sections R1 to R3 by forming the divided sections R1 to R3 by the groove portions 15a. Accordingly, when both the oil and the refrigerant are applied as illustrated in FIG. 5B, the oil and the refrigerant are not mixed in adjacent two of the divided sections R1 to R3. Thus, it is possible to reliably realize the desired average viscosity by setting the viscosity of the fluid in each of the divided sections R1 to R3 to be substantially constant (in other words, the viscosity in each of the divided sections R1 to R3 does not fluctuate by mixing of the oil and the refrigerant). As a result, according to the present embodiment, it is possible to accurately control the load applied by the slide bearing 15.

As illustrated in FIG. 5B, the average viscosity in the slide bearing 15 at the time when both the oil and the refrigerant are applied varies according to lengths of the divided sections R1 to R3 along the axial direction. More specifically, the average viscosity varies according to a ratio between a sum of the lengths of the divided sections R1, R3, to each of which the oil is applied, along the axial direction, and the length of the divided section R2, to which the refrigerant is applied, along the axial direction. Thus, the length of each of the divided sections R1 to R3 along the axial direction only needs to be set according to the desired average viscosity to be realized.

### Electrical Configuration

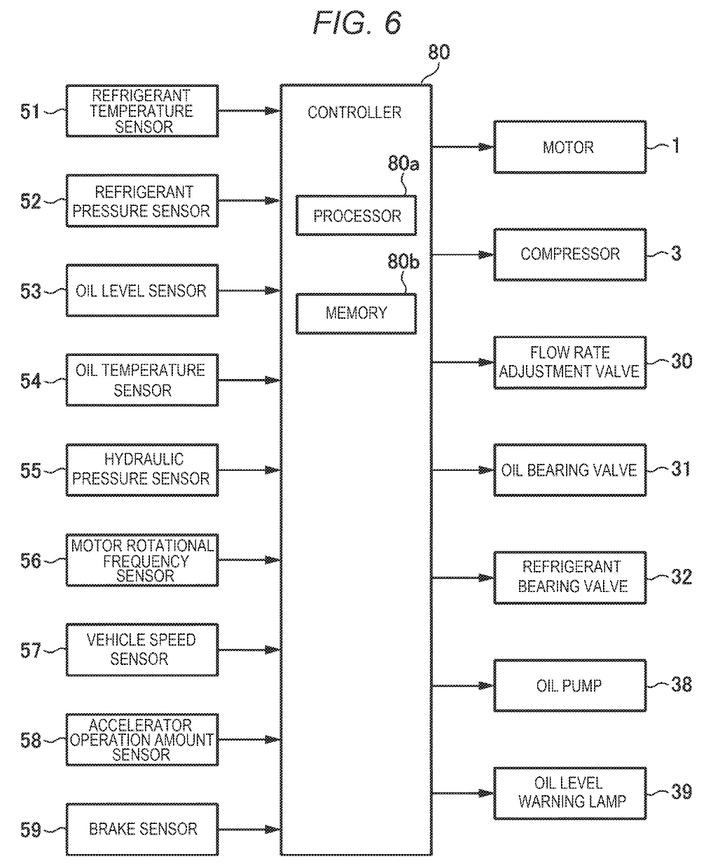

Next, an electrical configuration of the bearing system 200 according to the present embodiment will be described with reference to FIG. 6. FIG. 6 is a block diagram illustrating the electrical configuration of the bearing system 200 according to the present embodiment.

As illustrated in FIG. 6, the bearing system 200 includes a controller 80 that is configured to execute various types of control in the system. The controller 80 is configured with a computer that includes: one or more processors 80a (typically Central Processing Units (CPUs)); and memory 80b, such as Read-Only Memory (ROM) or Random Access Memory (RAM), that stores various programs (including a basic control program such as an Operating System (OS) and an application program activated on the OS to implement a particular function) interpretively executed on the processor 80a and various types of data.

The bearing system 200 includes, in addition to the sensors 51 to 55 described above (see FIG. 2): a motor rotational frequency sensor 56 that detects a motor rotational frequency of the motor 1 (rotational frequencies of the rotor 11 and the rotation shaft 13, being equivalent to the rotational frequency); a vehicle speed sensor 57 that detects a speed (a vehicle speed) of the vehicle 300; an accelerator operation amount sensor 58 that detects an accelerator operation amount corresponding to a depression amount of an accelerator pedal in the vehicle 300; and a brake sensor 59 that detects an operation of a brake pedal in the vehicle 300.

The controller 80 supplies a control signal to the motor 1, the compressor 3, the flow rate adjustment valve 30, the oil bearing valve 31, the refrigerant bearing valve 32, the oil pump 38, and an oil level warning lamp 39 on the basis of detection signals from these sensors 51 to 59. The oil level warning lamp 39 is a lamp for warning that the level of the oil stored in the oil tank 6 (detected by the oil level sensor 53) is lower than a predetermined value.

In the present embodiment, the controller 80 mainly controls opening/closing of each of the oil bearing valve 31 and the refrigerant bearing valve 32 in order to switch the fluid supplied to the divided section R2 of the slide bearing 15 between the oil and the refrigerant on the basis of the motor rotational frequency detected by the motor rotational frequency sensor 56, or the like. More specifically, based on the motor rotational frequency, the controller 80 selectively executes control for opening the oil bearing valve 31 and closing the refrigerant bearing valve 32 to supply the oil to the divided section R2, and control for closing the oil bearing valve 31 and opening the refrigerant bearing valve 32 to supply the refrigerant to the divided section R2.

### Control Method

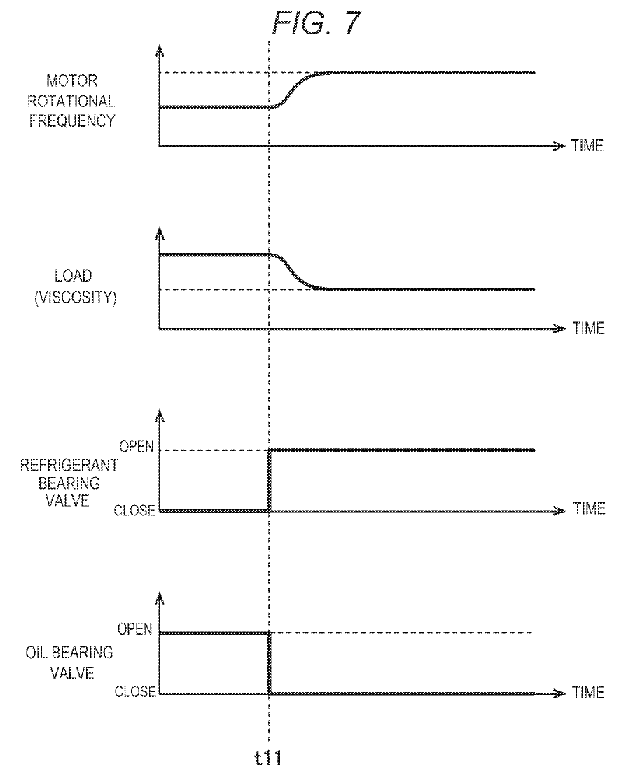

Next, a specific description will be made on the control executed by the controller 80 of the bearing system 200 in the present embodiment. First, a flow of the control executed by the controller 80 in the present embodiment will be described with reference to FIG. 7. FIG. 7 is a time chart illustrating the control according to the present embodiment. FIG. 7 illustrates, in an order from the top, temporal changes in the motor rotational frequency, the load applied by the slide bearing 15 (corresponding to the viscosity of the fluid in the slide bearing 15), opening/closing of the refrigerant bearing valve 32, and opening/closing of the oil bearing valve 31.

As illustrated in FIG. 7, the motor rotational frequency is increased at time t11. As a result, the load to be realized by the slide bearing 15 (hereinafter, referred to as a "required load") that is determined according to the motor rotational frequency is reduced. Accordingly, at such time t11, the controller 80 executes control for closing the oil bearing valve 31 and opening the refrigerant bearing valve 32 to switch the fluid supplied to the divided section R2 of the slide bearing 15 from the oil to the refrigerant in order to suppress the load of the slide bearing 15.

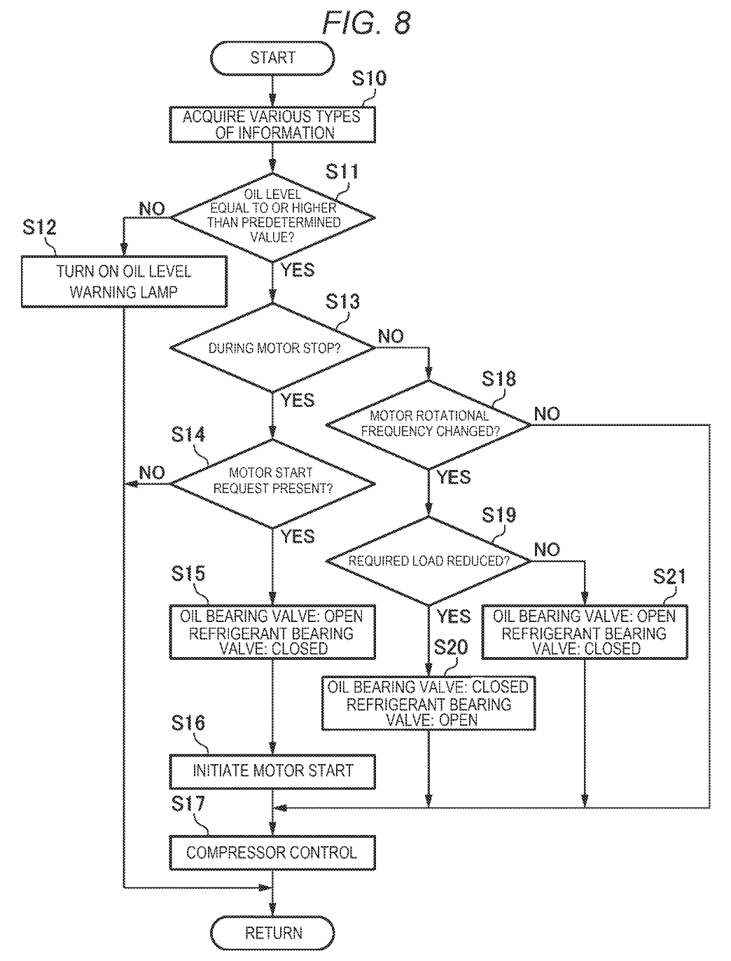

Next, a description will be made on a flowchart illustrating specific control according to the present embodiment with reference to FIG. 8. This flow is repeatedly executed by the controller 80 in a predetermined cycle. In detail, the processor 80a in the controller 80 reads the program stored in the memory 80b to execute the program, and thereby realizes the control for this flow.

First, in step S10, the controller 80 acquires various types of information such as the detection values detected by the sensors 51 to 59 (FIG. 6) described above. Then, the processing proceeds to step S11, and the controller 80 determines whether the oil level detected by the oil level sensor 53 is equal to or higher than the predetermined value. As a result, if the controller 80 does not determine that the oil level is equal to or higher than the predetermined value (step S11: No), that is, if the oil level is lower than the predetermined value, the processing proceeds to step S12, and the oil level warning lamp 39 is turned on.

On the other hand, if the controller 80 determines that the oil level is equal to or higher than the predetermined value in step S11 (step S11: Yes), the processing proceeds to step S13. In step S13, the controller 80 determines whether the motor 1 is stopped on the basis of the motor rotational frequency detected by the motor rotational frequency sensor 56, and the like. As a result, if the controller 80 determines that the motor 1 is stopped (step S13: Yes), the processing proceeds to step S14, and it is determined whether there is a motor start request on the basis of a start switch of the vehicle 300, the accelerator operation amount detected by the accelerator operation amount sensor 58, or the like. As a result, if the controller 80 determines that there is the motor start request (step S14: Yes), the processing proceeds to step S15. On the other hand, if not determining that there is the motor start request (step S14: No), the controller 80 terminates the control according to this flow.

In step S15, the controller 80 opens the oil bearing valve 31 and closes the refrigerant bearing valve 32 to supply the oil to the divided section R2 of the slide bearing 15 in order to secure the load of the slide bearing 15 before the motor 1 is started. Then, the processing proceeds to step S16 to start the motor 1 and then proceeds to step S17, and the controller 80 executes control for adjusting the rotational frequency of the compressor 3.

On the other hand, if the controller 80 does not determine that the motor 1 is stopped in step S13 (step S13: No), that is, if the motor 1 is already in operation, the processing proceeds to step S18. In step S18, the controller 80 calculates a motor target rotational frequency on the basis of the accelerator operation amount detected by the accelerator operation amount sensor 58, or the like, and determines whether this motor target rotational frequency is changed. As a result, if the controller 80 determines that the motor target rotational frequency is changed (step S18: Yes), the processing proceeds to step S19. On the other hand, if it does not determine that the motor target rotational frequency is changed (step S18: No), the processing proceeds to step S17 without the processing in steps S19 to S21 being executed.

In step S19, the controller 80 calculates the required load of the slide bearing 15 on the basis of the motor rotational frequency detected by the motor rotational frequency sensor 56, or the like, and determines whether this required load is reduced. In this case, the required load tends to be reduced as the motor rotational frequency is increased. As a result of step S19, if the controller 80 determines that the required load is reduced (step S19: Yes), the processing proceeds to step S20. In this case, since the motor rotational frequency is increased, the controller 80 closes the oil bearing valve 31 and opens the refrigerant bearing valve 32 to supply the refrigerant to the divided section R2 of the slide bearing 15 in order to suppress the load of the slide bearing 15. Then, the processing proceeds to step S17 described above.

On the other hand, if the controller 80 does not determine that the required load is reduced (step S19: No), that is, if the required load is increased, the processing proceeds to step S21. In this case, since the motor rotational frequency is reduced, the controller 80 opens the oil bearing valve 31 and closes the refrigerant bearing valve 32 to supply the oil to the divided section R2 of the slide bearing 15 in order to secure the load of the slide bearing 15. Then, the processing proceeds to step S17 described above.

Here, in step S19, the controller 80 determines whether the required load of the slide bearing 15 is reduced. However, in another example, instead of making such a determination, it may be determined whether the motor rotational frequency is equal to or higher than the predetermined value.

### Operation and Effects

Next, operation and effects of the bearing system 200 according to the present embodiment will be described.

In the present embodiment, the slide bearing 15 of the bearing system 200 includes the two groove portions 15a that are formed on the sliding surface of the slide bearing 15 and extend in the radial direction and the circumferential direction, and these groove portions 15a divide the sliding surface of the slide bearing 15 into the plurality of divided sections R1 to R3 in the axial direction. In addition, the slide bearing 15 includes: the discharge hole 15b that is formed in the groove portions 15a to discharge the fluid from the slide bearing 15; and the plurality of supply holes 15c1 to 15c4 for supplying the fluid to the divided sections R1 to R3 that are divided by the groove portions 15a. The slide bearing 15 is further configured to respectively supply the oil and the refrigerant (the CO₂ refrigerant) having the differing viscosities from the supply hole 15c2 and the supply hole 15c4 to the single divided section R2 of the plurality of divided sections R1 to R3.

According to such a present embodiment, the divided sections R1 to R3 are formed in the axial direction by the two groove portions 15a, and the oil and the refrigerant are separately supplied from the supply hole 15c2 and the supply hole 15c4, respectively, to the divided section R2 thereof. In this way, it is possible to appropriately change the viscosity of the divided section R2. As a result, it is possible to change the average viscosity of the fluid in the slide bearing 15 and to control the load of the slide bearing 15. In particular, in the present embodiment, since the divided sections R1 to R3 are formed by the groove portions 15a, and these groove portions 15a are each provided with the discharge hole 15b, the fluid in each of the divided sections R1 to R3 flows out from the respective discharge hole 15b through respective one of the groove portions 15a that define the divided sections R1 to R3. Thus, it is possible to prevent the fluids from being mixed in adjacent two of the divided sections R1 to R3. Accordingly, since the viscosity in each of the divided sections R1 to R3 does not fluctuate due to mixing of the oil and the refrigerant, the viscosity of the fluid in each of the divided sections R1 to R3 can be accurately adjusted. Thus, it is possible to realize the desired average viscosity in the slide bearing 15. Therefore, according to the present embodiment, since the load of the slide bearing 15 can be accurately controlled, it is possible to accurately and simultaneously secure the load capacity of the slide bearing 15 and reduce the friction without complicating the control configuration and the like in comparison with a configuration wherein the viscosity of the fluid is changed by adjusting the mixing ratio of the plurality of fluids as described above.

In addition, according to the present embodiment, based on the motor rotational frequency (including the required load that is set on the basis of the motor rotational frequency), the controller 80 selectively executes the control for opening the oil bearing valve 31 and closing the refrigerant bearing valve 32 to supply the oil to the divided section R2, and the control for closing the oil bearing valve 31 and opening the refrigerant bearing valve 32 to supply the refrigerant to the divided section R2. In this way, it is possible to secure the load capacity of the slide bearing 15 in the low rotation range while it is possible to reduce the friction (lubrication resistance) of the slide bearing 15 in the high rotation range.

According to the present embodiment, the two groove portions 15a of the slide bearing 15 are arranged such that the lengths of the plurality of divided sections R1 to R3 along the axial direction differ from each other. Accordingly, by appropriately setting the length along the axial direction of each of the divided sections R1 to R3, it is possible to realize the desired average viscosity when both the oil and the refrigerant are applied to the slide bearing 15.

### Modified Examples

A description will herein be made on modified examples of the above-described embodiment.

### First Modified Example

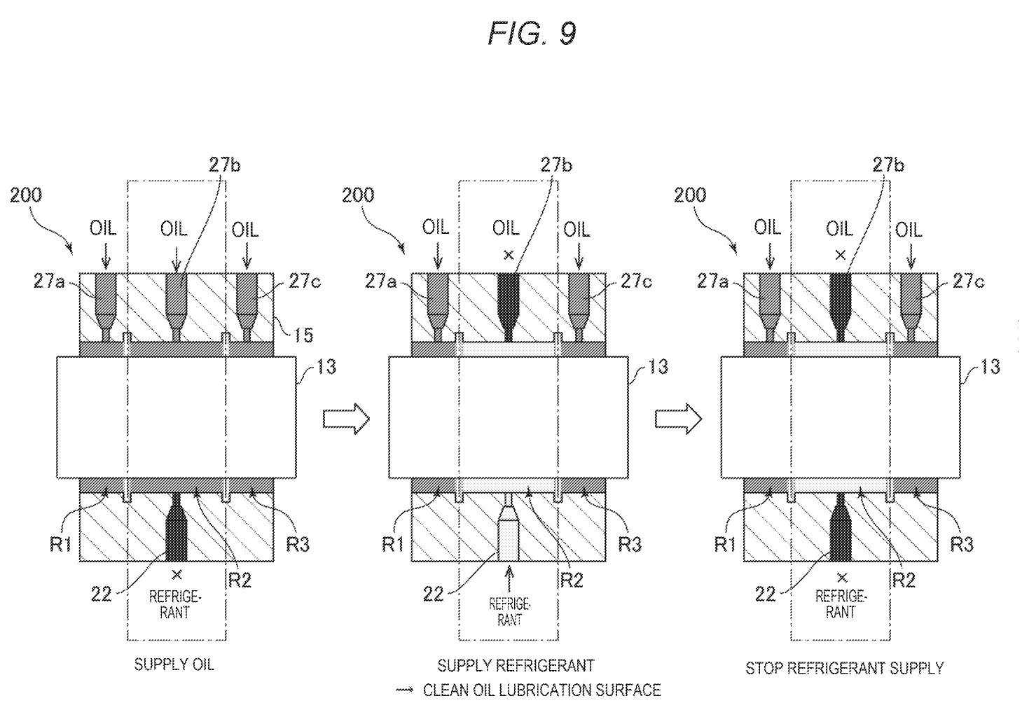

A description will be made on control according to a first modified example of the present embodiment with reference to FIG. 9. Similar to FIG. 5, FIG. 9 illustrates the supply state of the oil or the refrigerant in one (the slide bearing 15 illustrated on the left in FIG. 3, that is, the slide bearing 15 on the side where the seal member 18 is provided) of the paired slide bearings 15.

A left side of FIG. 9 illustrates a situation where the oil is supplied to the divided section R2 of the slide bearing 15 in order to secure the load capacity of the slide bearing 15 due to the relatively low motor rotational frequency. When the motor rotational frequency is increased relatively from this situation, in the embodiment described above, the controller 80 stops the supply of the oil to the divided section R2 and supplies the refrigerant to the divided section R2 in order to reduce the friction by the oil in the slide bearing 15 (FIGS. 7 and 8). However, it can be said that the refrigerant has little effect on the load capacity even when the refrigerant is supplied to the divided section R2, just as described (due to the low load capacity of the refrigerant). In this case, it is considered that the load capacity can be sufficiently secured by the oil that is supplied to the divided sections R1, R3. Meanwhile, it can be said that wasteful energy consumption occurs when the refrigerant is prepared to be supplied to the divided section R2. From the above, it can be said that the refrigerant does not have to be supplied to the divided section R2 when the motor rotational frequency is relatively high. A reason for the above description is because the slide bearing 15 is mainly designed to be lubricated by the oil. More specifically, this is because the gap between the rotation shaft 13 of the motor 1 and the slide bearing 15 is widely designed for the lubrication by the oil, that is, the gap is too wide to exert the load capacity by the refrigerant.

Accordingly, in the first modified example, after the supply of the oil to the divided section R2 is stopped, the refrigerant is not supplied to the divided section R2. In this case, there is a problem that the oil remains in the divided section R2 after the stop of the supply of the oil to the divided section R2, causing drag resistance from this oil. Accordingly, in the first modified example, after the supply of the oil to the divided section R2 is stopped, as illustrated in a center of FIG. 9, the controller 80 supplies the refrigerant to the divided section R2 for a predetermined time and thereby cleans the oil remaining in the divided section R2 with the refrigerant (that is, cleans an oil lubrication surface). Then, in the first modified example, after supplying the refrigerant to the divided section R2 for a predetermined time, as illustrated on the right in FIG. 9, the controller 80 stops the supply of the refrigerant to the divided section R2.

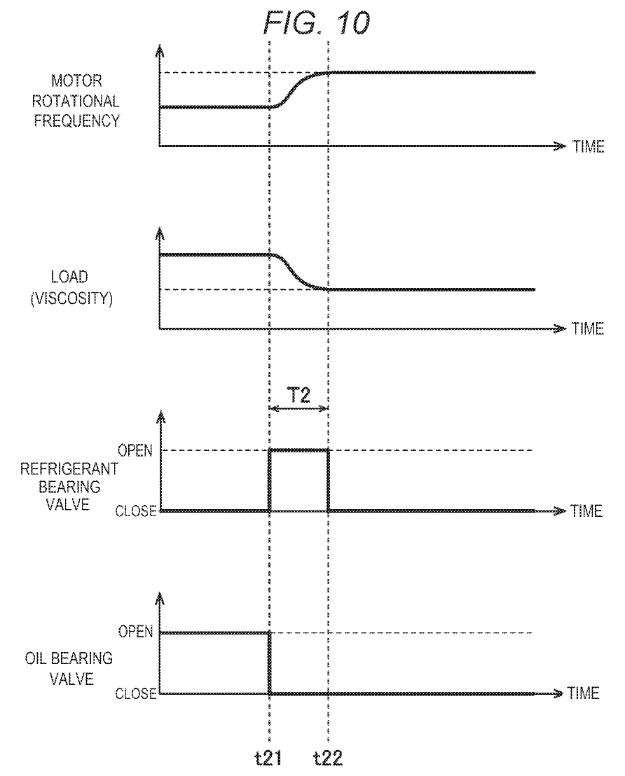

Next, a flow of the control executed by the controller 80 in the first modified example will be described with reference to FIG. 10. FIG. 10 is a time chart illustrating the control according to the first modified example. FIG. 10 illustrates, in an order from the top, temporal changes in the motor rotational frequency, the load applied by the slide bearing 15 (corresponding to the viscosity of the fluid in the slide bearing 15), opening/closing of the refrigerant bearing valve 32, and opening/closing of the oil bearing valve 31.

As illustrated in FIG. 10, the motor rotational frequency is increased at time t21. Consequently, the required load that is determined according to the motor rotational frequency is reduced. Accordingly, at such time t21, the controller 80 executes control for closing the oil bearing valve 31 to stop the supply of the oil to the divided section R2 of the slide bearing 15 in order to suppress the load of the slide bearing 15. At the same time, the controller 80 executes control for opening the refrigerant bearing valve 32 to supply the refrigerant to the divided section R2 in order to clean the oil remaining in the divided section R2 with the refrigerant. Thereafter, at time t22 when a predetermined time T2 has elapsed from the time t21, the controller 80 executes control for closing the refrigerant bearing valve 32 to stop the supply of the refrigerant to the divided section R2.

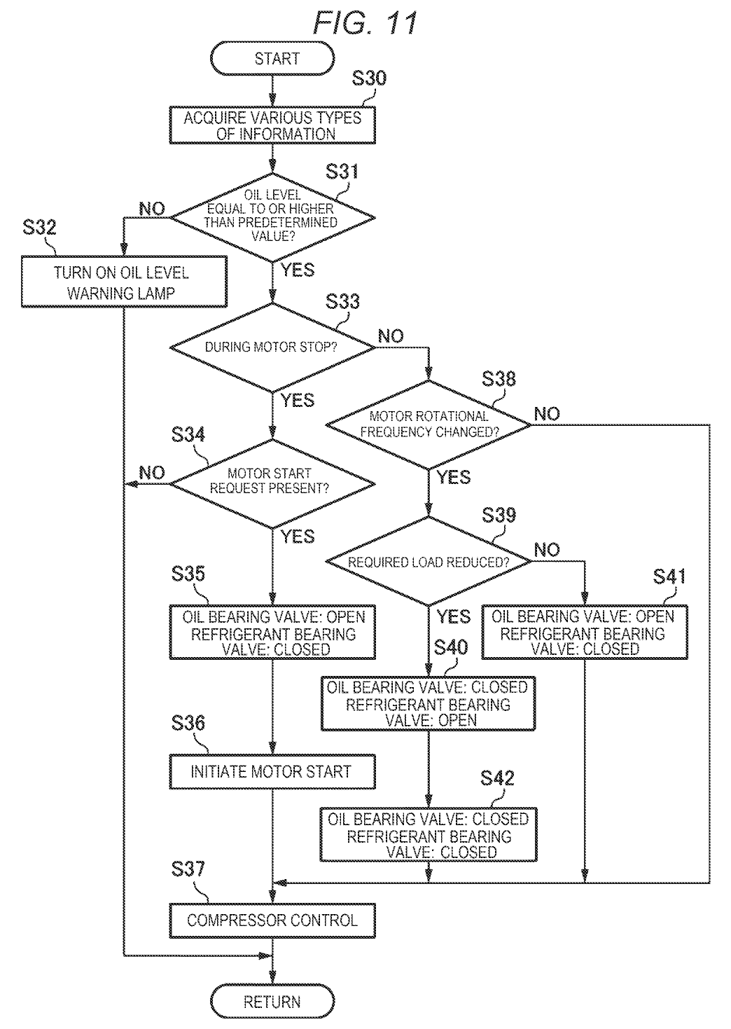

Next, a description will be made on a flowchart illustrating specific control according to the first modified example with reference to FIG. 11. This flow is also repeatedly executed by the controller 80 in the predetermined cycle. In detail, the processor 80a in the controller 80 reads the program stored in the memory 80b to execute the program, and thereby realizes the control for this flow.

Since steps S30 to S41 in FIG. 11 are the same as steps S10 to S21 in FIG. 8, respectively, the description on these will not be made, and the description will be mainly made on step S42. Step S42 is executed after step S40. In this step S40, the controller 80 executes the control for closing the oil bearing valve 31 and opening the refrigerant bearing valve 32 to supply the refrigerant to the divided section R2 in order to clean the oil remaining in the divided section R2 of the slide bearing 15 with the refrigerant. Then, when the predetermined time T2 elapses after this control, the processing proceeds to step S42, and the controller 80 executes control for closing the refrigerant bearing valve 32 while keeping the oil bearing valve 31 closed in order to stop the supply of the refrigerant to the divided section R2.

According to such a first modified example, after the supply of the oil to the divided section R2 of the slide bearing 15 is stopped, the refrigerant is supplied to the divided section R2 to clean out the oil remaining in the divided section R2 with the refrigerant. Thus, it is possible to suppress the resistance caused by drag from the oil. In addition, according to the first modified example, the supply of the refrigerant to the divided section R2 is stopped after the oil remaining in the divided section R2 is cleaned with the refrigerant, just as described. Thus, it is possible to suppress the wasteful energy consumption of preparing the refrigerant for the divided section R2.

### Second Modified Example

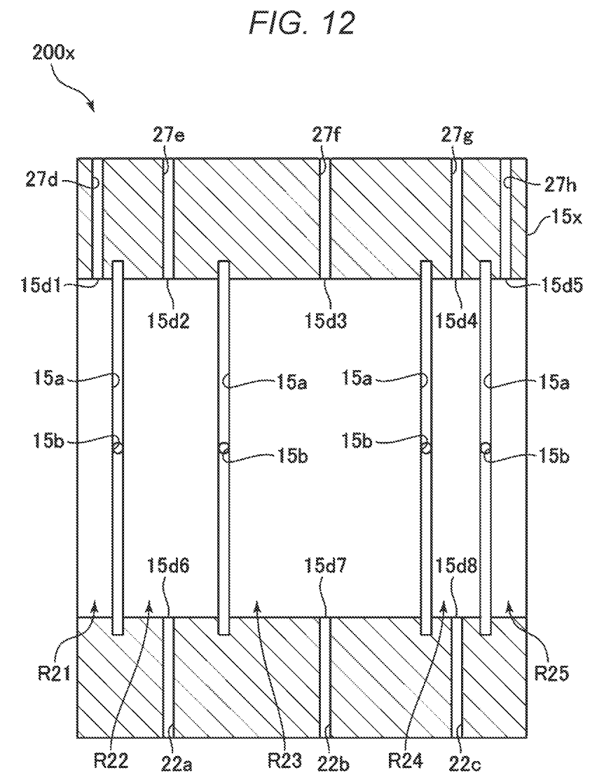

A description will be made on a configuration of a bearing system 200x according to a second modified example of the present embodiment with reference to FIG. 12. Similar to FIG. 4B, FIG. 12 is a cross-sectional view in which one of paired slide bearings 15x in the bearing system 200x according to the second modified example is viewed along the axial direction.

As illustrated in FIG. 12, the slide bearing 15x according to the second modified example has the four groove portions 15a, each of which includes the discharge hole 15b, and these four groove portions 15a divide a sliding surface of the slide bearing 15x into five divided sections R21 to R25 in the axial direction. For example, a ratio of the divided sections R21, R22, R23, R24, R25 along the axial direction is 6.25:25:50:12.5:6.25. The slide bearing 15 also includes: supply holes 15d1 to 15d5 that communicate with oil passages 27d to 27h for supplying the oil to the divided sections R21 to R25, respectively; and supply holes 15d6 to 15d8 that communicate with refrigerant passages 22a to 22c for supplying the refrigerant to the divided sections R22 to R24, respectively. In this case, while only the oil is supplied to the divided sections R21, R25, and either the oil or the refrigerant is selectively supplied to the divided sections R22 to R24.

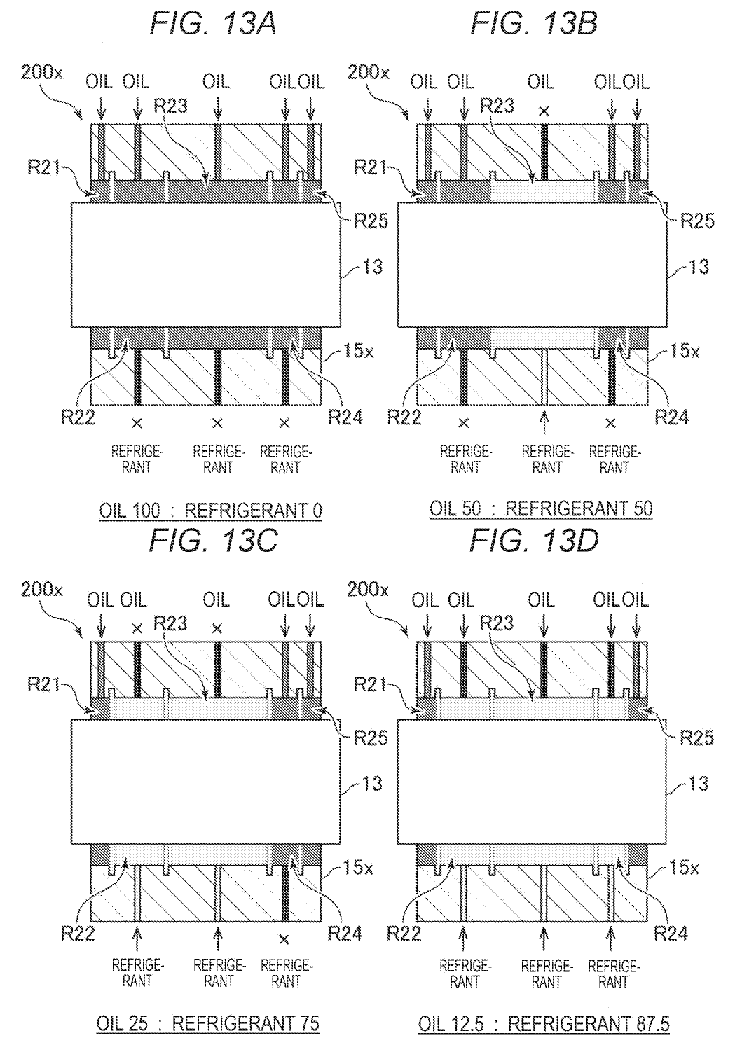

Next, a description will be made on control of the bearing system 200x according to the second modified example with reference to FIG. 13. Similar to FIG. 5, FIGS. 13A to 13D illustrate the supply state of the oil or the refrigerant in one of the paired slide bearings 15x.

FIG. 13A illustrates a case where the oil is supplied to all of the divided sections R21 to R25. In this case, a ratio of the oil and the refrigerant in the slide bearing 15x is 100:0 (an oil ratio is 100%). FIG. 13B illustrates a case where the oil is supplied to the divided sections R21, R22, R24, R25 while the refrigerant is supplied to the divided section R23. In this case, the ratio of the oil and the refrigerant in the slide bearing 15x is 50:50 (the oil ratio is 50%) from a relationship among the lengths along the axial direction of the divided sections R21 to R25 described above. FIG. 13C illustrates a case where the oil is supplied to the divided sections R21, R24, R25 while the refrigerant is supplied to the divided sections R22, R23. In this case, the ratio of the oil and the refrigerant in the slide bearing 15x is 25:75 (the oil ratio is 25%). FIG. 13D illustrates a case where the oil is supplied to the divided sections R21, R25 while the refrigerant is supplied to the divided sections R22, R23, R24. In this case, the ratio of the oil and the refrigerant in the slide bearing 15x is 12.5:87.5 (the oil ratio is 12.5%).

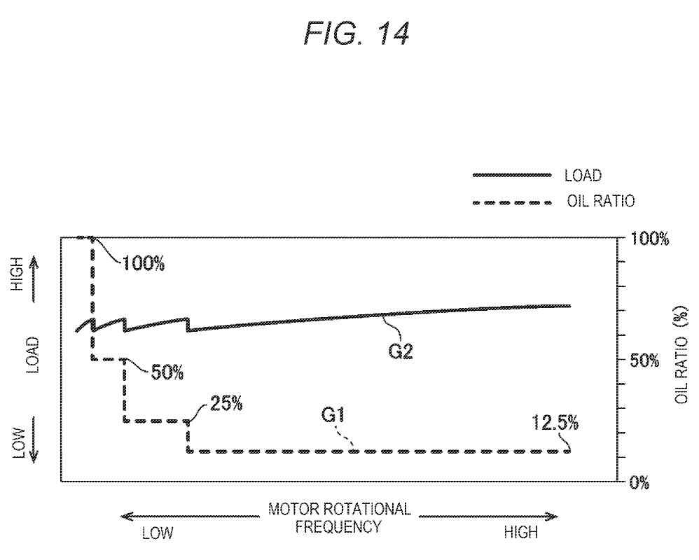

Next, a description will be made on a load of the slide bearing 15x realized by the second modified example with reference to FIG. 14. In FIG. 14, a graph G1 (a broken line) indicates the oil ratios as percentages (100%, 50%, 25%, 12.5%) that are realized in a stepwise manner by switching between the oil and the refrigerant supplied to each of the divided sections R22 to R24. A graph G2 (a solid line) indicates the load of the slide bearing 15x that is realized when such oil ratios are set. Thus, according to the second modified example, the load of the slide bearing 15x can be switched in multiple stages by using a large number of the divided sections R21 to R25. As a result, according to the second modified example, it is possible to effectively reduce the friction of the slide bearing 15 in the high rotation range while securing the load capacity of the slide bearing 15 in the low rotation range.

### Other Modified Examples

In the embodiment described above, the oil and the refrigerant are supplied to the divided section R2 of the three divided sections R1 to R3 of the slide bearing 15. However, in a modified example, the oil and the refrigerant may be supplied to the divided sections R1, R3 instead of the divided section R2. In a further modified example, the oil and the refrigerant may be supplied to the divided sections R1, R3 in addition to the divided section R2. That is, the supply of the oil and the refrigerant is not limited to only the divided section R2 as a part of the divided sections R1 to R3. In the modified examples, the oil and the refrigerant may be supplied to all of the divided sections R1 to R3.

In addition, in the embodiment described above, both of the supply hole 15c2 and the supply hole 15c4 are used to switch the viscosity of the fluid to be supplied to the divided section R2 of the slide bearing 15, that is, to switch the supplied fluid between the oil and the refrigerant. However, in a modified example, only one supply hole may be used. In this case, on an upstream side of the supply hole, the fluid to be supplied to the one supply hole may be switched between the oil and the refrigerant.

Furthermore, in the embodiment described above, the three divided sections R1 to R3 are formed in the slide bearing 15 by the two groove portions 15a. In the second modified example described above, the five divided sections R21 to R25 are formed in the slide bearing 15x by the four groove portions 15a. However, in a modified example, two divided sections may be formed by the single groove portion 15a, or six or more divided sections may be formed by the five or more groove portions 15a.

In the embodiment described above, the oil and CO₂ refrigerant are used as examples of the fluids having the different viscosities. However, any of various fluids other than the oil and CO₂ may be used, or three or more fluids having different viscosities may be used.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

1: motor

3: compressor

5: heat exchanger

6: oil tank

11: rotor

12: stator

13: rotation shaft

15, 15X: slide bearing

15a: groove portion

15b: discharge hole

15c1 to 15c4: supply hole

21 to 26: refrigerant passage

27, 28: oil passage

29: mixed fluid passage

80: controller

100: refrigerant circulation system

200, 200x: bearing system

300: vehicle

R1 to R3, R21 to R25: divided section

1. A bearing system that supports a rotation shaft, the bearing system comprising:
a slide bearing lubricated by a fluid, the slide bearing supporting the rotation shaft, wherein
the slide bearing includes:
a groove portion that is formed on a sliding surface of the slide bearing and extends in a radial direction and a circumferential direction, the groove portion dividing the sliding surface into a plurality of sections in an axial direction;
a discharge hole that is formed in the groove portion to discharge the fluid from the slide bearing; and
a plurality of supply holes for supplying the fluid to the plurality of sections, which are divided by the groove portion, respectively, and
the slide bearing is configured to supply each of the plurality of fluids having different viscosities from the respective supply hole to one or more predetermined sections of the plurality of sections.

2. The bearing system according to claim 1, wherein the slide bearing is supplied with the fluids having the different viscosities from the plurality of supply holes, respectively.

3. The bearing system according to claim 1, wherein
the plurality of sections comprise three or more sections, and
the groove portion is one of two or more groove portions of the slide bearing that are provided to form the three or more sections.

4. The bearing system according to claim 1, wherein the groove portion of the slide bearing is arranged such that lengths along the axial direction of the plurality of sections differ from each other.

5. The bearing system according to claim 1, wherein the plurality of supply holes include two supply holes, and the plurality of fluids include a first fluid and a second fluid having a lower viscosity than the first fluid.

6. The bearing system according to claim 5, further comprising:
a first passage and a second passage that respectively communicate with the two supply holes and supply the first fluid and the second fluid;
a first valve and a second valve respectively provided in the first passage and the second passage; and
a controller that controls opening/closing of each of the first valve and the second valve to switch the fluid to be supplied to the predetermined section between the first fluid and the second fluid.

7. The bearing system according to claim 6, wherein based on a rotational frequency of the rotation shaft, the controller selectively executes a control for opening the first valve and closing the second valve to supply the first fluid to the predetermined section and a control for closing the first valve and opening the second valve to supply the second fluid to the predetermined section.

8. The bearing system according to claim 6, wherein the controller executes the control for opening the first valve and closing the second valve to supply the first fluid to the predetermined section, thereafter executes the control for closing the first valve and opening the second valve to supply the second fluid to the predetermined section, and, after this control, executes a control for closing the first and second valves to stop supply of the first and second fluids to the predetermined section.

9. The bearing system according to claim 8, wherein the plurality of fluids include oil and CO₂.

10. The bearing system according to claim 9, wherein the rotation shaft of a motor is supported by the slide bearing.

11. The bearing system according to claim 1, wherein the plurality of fluids include oil and CO₂.

12. The bearing system according to claim 2, wherein the plurality of fluids include oil and CO₂.

13. The bearing system according to claim 3, wherein the plurality of fluids include oil and CO₂.

14. The bearing system according to claim 4, wherein the plurality of fluids include oil and CO₂.

15. The bearing system according to claim 5, wherein the plurality of fluids include oil and CO₂.

16. The bearing system according to claim 6, wherein the plurality of fluids include oil and CO₂.

17. The bearing system according to claim 7, wherein the plurality of fluids include oil and CO₂.
